(19) United States
(12) Patent Application Publication
(10) Pub. No.: US 2002/0133609 A1
(43) Pub. Date: Sep. 19, 2002

(54) Universal method and apparatus for communication between devices

(76) Inventor: Thomas W. Baker, Orefield, PA (US)

Correspondence Address: HITT GAINES & BOISBRUN P.C., P.O. BOX 832570, RICHARDSON, TX, 75083, US

(21) Appl. No.: 09/811,662

(22) Filed: Mar. 19, 2001

(51) Int. Cl. G06F 15/16

(52) U.S. Cl. 709/230; 709/201

(57) ABSTRACT

Apparatus and method of the present invention, is able to receive information written in a non-negotiated language, such as Extensible Markup Language (XML), and determine to what extent the information can be discerned. If the information can be discerned, it is processed to the extent it is capable of being discerned. Otherwise, to the extent the information is not capable of being discerned information is disregarded and not processed. In further aspects of the present invention, multiple messages may be broadcast and received by the apparatus and method of the present invention. Such messages may be broadcast in a wired environment or a wireless environment without the need for a predetermined fixed handshaking protocol, to systems, such as a personal digital assistant.

### TECHNICAL FIELD OF THE INVENTION

The present invention is directed, in general, to wired and wireless communication techniques and, more specifically, to a method and apparatus for receiving information by a global protocol.

### BACKGROUND OF THE INVENTION

Two or more connected devices or services use information and protocols between them to set up and manage connections. Existing communications methods and apparatus between two or more devices follow fixed sets of rules. Specific protocols and codes are programmed into each device. The protocols usually involve the exchange of numbers representing states. Some protocol numbers represent significant states that are also useful to represent as an icon or some other useful information.

Fixed rules and protocols require either that all devices are updated together in order to continue to communicate, or that each device maintains multiple versions of protocols such that it can determine through other fixed protocols what level of communication is supported by a given device, and use an appropriate method of communication.

Current methods of communication between devices follow a fixed series of “handshakes” to identify the device, and at what level they can communicate. More advanced devices must step backwards to a lower level, or previous version of protocols in order to communicate with a less sophisticated device, thus disabling some of its advanced features.

Fixed methods of communications are disadvantageous because they force each device to store numerous versions of software to support multiple devices at multiple levels, as well as require manual reconfiguration of the device as new services are deployed.

Accordingly, what is needed in the art is a method of communication that allows devices to exchange information without fixed and limiting protocols or numerous conversion procedures, and that also allows future extensions to be included while maintaining backward compatibility for older devices.

### SUMMARY OF THE INVENTION

To address the above-discussed deficiencies of the prior art, the present invention provides a universal method and apparatus for communication between two devices. A method in accordance with the present invention receives a message expressed in a non-negotiated language. The message is parsed to determine to what extent the message is capable of being discerned and processed. In a further aspect of the present invention, portions of a message are disregarded to the extent that those portions cannot be discerned.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of a receiving device in accordance with the invention.

FIG. 2 illustrates a block diagram of a processor within a receiving device in accordance with the invention.

FIG. 3 illustrates a message in accordance with the invention.

FIG. 4 illustrates a structured message in accordance with the invention.

FIG. 5 illustrates a flow diagram of an exemplary device; and

FIG. 6 illustrates a block diagram of a wireless environment operating in accordance with the invention.

### DETAILED DESCRIPTION

Referring initially to FIG. 1, illustrated is an embodiment of a receiving device 100 that operates in accordance with the principles of the present invention. The receiving device 100 includes: a buffer 102 and a processor 106 that handles a received message (not shown) on input path 108. Messages received by the receiving device 100 are initially stored in buffer 102. Assuming the message is in a format that requires conversion, processor 106 determines whether the message is capable of being processed, by ascertaining whether processor 106 recognizes any discemable messages. As shall come apparent to those skilled in the art, the receiving device 100 may take the form of any device, whether fixed or wireless, that receives information or messages from some sort of sending device. For example, receiving device 100 may be a personal digital assistant, a mobile telephone, a wired telephone, a personal computer, a printer, or any other device capable of receiving data. To the extent that receiving device 100 operates in a domain where conversion is not necessary, it is appreciated that an optional decoder may be required.

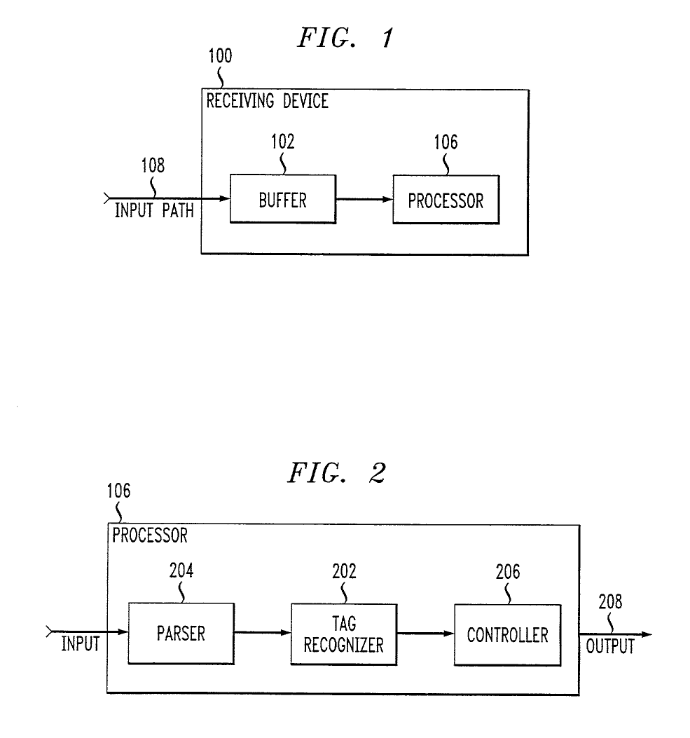

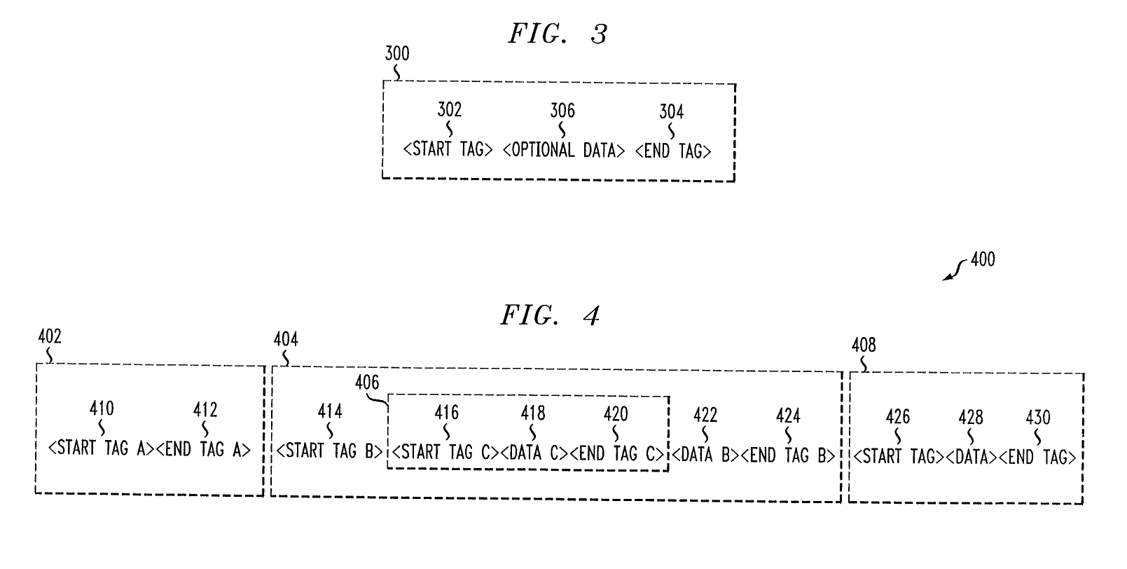

FIG. 2 illustrates a block diagram of processor 106 in accordance with one embodiment of the present invention. Processor 106 includes a tag recognizer 202 and controller 206. Tag recognizer 202 determines to what extent processor 106 can process a received message or data, by analyzing tags in the message (an example message is shown with reference to FIG. 3). Controller 206 processes the message, based on the determination performed by tag recognizer 202, and disregards any unrecognized tags and their data.

In one aspect of the invention, the tag recognizer 202 determines the extent the message can be processed by comparing a current tag in the received message with a table (not shown) having a list of known tags. If the current tag is in the table, then the message can be processed. If the current tag is not in the table, then the message is disregarded or ignored by processor 106.

Controller 206 processes the messages with tags that are recognized by the tag recognizer 202. Controller 206 generates an output signal 208 based upon a portion of the message it processes. The portion of the message can be the data portion, the tag portion, or both (again details of an example message are illustrated in FIG. 3). A generated output signal 208 is used to control a variety of systems or devices. Tag recognizer 202 and controller 206 are implemented in hardware, software, or any combination thereof, for executing instructions. For example, tag recognizer 202 and the controller 206 may be implemented in a digital signal processor (DSP) executing a set of software instructions, a software program, or code in a programmable logic device.

The block diagram in FIG. 2 also includes a parser 204. The parser 204 parses the received message. In one aspect of the invention, parser 204 partitions a received message into message portions, wherein each message portion begins with a start tag 302 and ends with an end tag 304, as shown in FIG. 3. The general operation and implementation of “parsers” are known to those skilled in the art.

In an alternative embodiment, parser 204 may further process the message portions to determine if said messages are decipherable. For example, if start tag 302 of a given message portion is not decipherable, parser 204 may discard that message portion. If the start tag 302 of a given message portion is decipherable, the message portion is passed to controller 206. Controller 206 processes those messages or message portions determined to be decipherable. Controller 206 may execute one or more instructions associated with the comprehended message or message portion.

FIG. 3 illustrates a message 300 in accordance with one embodiment of the present invention. A message 300 includes a start tag 302 and an end tag 304. Message 300 can also include optional data 306, such as a payload. In the embodiment shown in FIG. 3, message 300 is in human readable format, i.e., start tag 302, end tag 304, and data 306 are text based. For example, text based languages may include Extensible Markup Language (XML), JAVA, portable document format, HTML and so forth. As would be appreciated by those skilled in the art, messages and data may take the form of any language or protocol and are not limited to a human readable format.

FIG. 4 shows an exemplary message 400 with multiple tags, data, and structure. The structure of message 400 allows multiple tags to appear in message 400 in a sequential format or a nested format or any combination thereof. Message 400 consists of message portion 402, message portion 404, message portion 406, and message portion 408. Message portion 402 consists of a start tag 410 and an end tag 412. Message portion 404 follows message portion 402 sequentially and consists of a start tag 414, message portion 406, data 422, and an end tag 424. Message portion 406, nested within message portion 404, consists of a start tag 416, data 418, and an end tag 420. Message portion 408 follows message portion 402 and message portion 404 sequentially. Message portion 408 consists of start tag 426, data 428, and end tag 430.

Contrary to a conventional communication device that follows a fixed protocol, receiving device 100 uses a non-negotiated communication language. Conventional devices often use fixed protocols programmed into both the receiving and transmitting devices. The protocols are fixed sets of rules that usually involve the exchange of numbers representing states. Conventional communication between devices also typically follows a fixed series of “handshakes” to identify the device and the version of protocol supported by each device. The “handshakes” in the protocol can continue throughout the communications, identifying when and what data will be sent to the receiving device.

In accordance with the present invention, the need for fixed protocols and series of “handshakes” between two devices are eliminated, because the two devices do not negotiate (non-negotiated) to determine a common software version or level of fixed protocols to follow for the communication. A message is transmitted and receiving device 100 determines to what extent the message is capable of being discerned, and if discernable, processes the message to the extent the message is discernable. If receiving device 100 cannot discern the message, it may, for example, discard, ignore, store or send the message to another device. The incoming message can be as long as desired, i.e., there is no limit to the length of the start tag, end tag, or data field. A message, however, typically contains a start tag and an end tag if written in human readable text language format. It is not necessary to determine whether two devices employ the same language or protocols prior to sending or receiving messages.

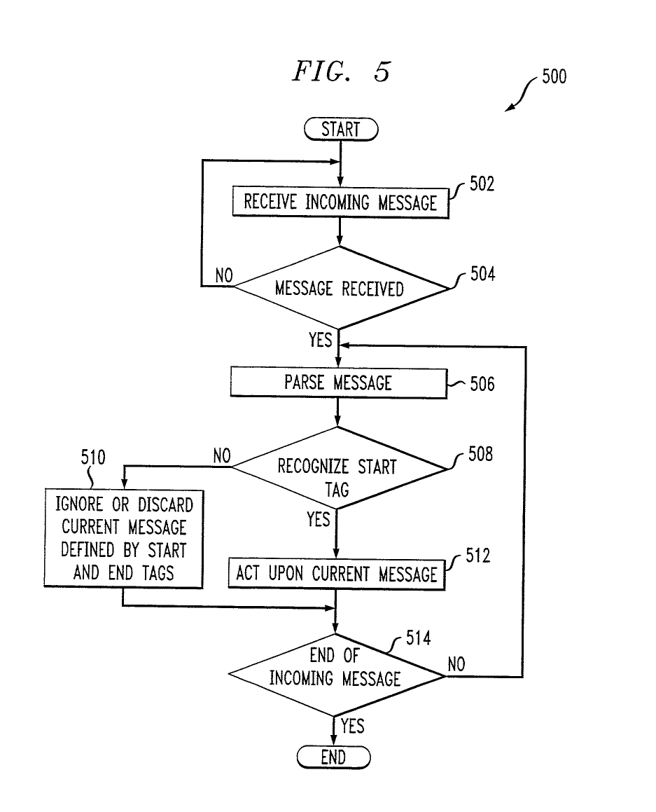

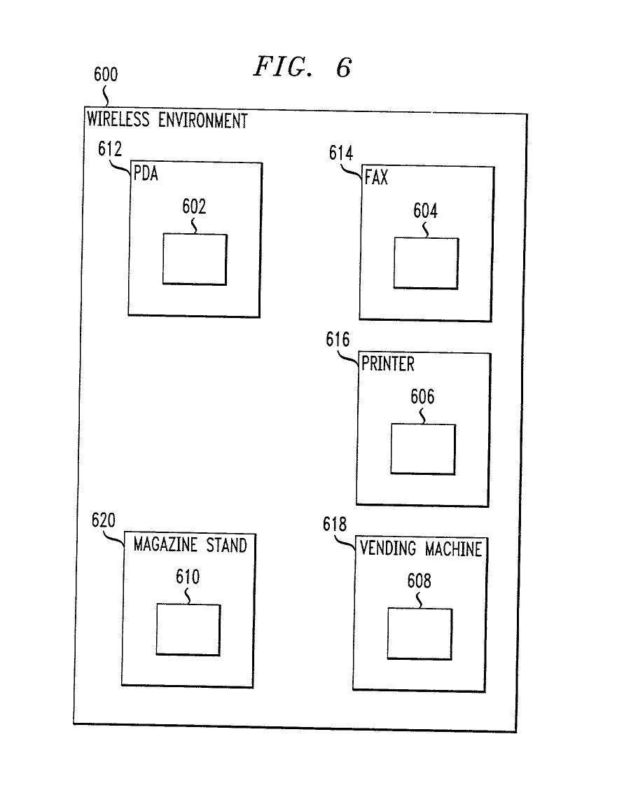

FIG. 5 is a flow chart illustrating a sequence of steps 500 executed by the receiving device 100 of FIG. 1 in accordance with an embodiment of the present invention. The sequence of steps 500 includes receiving a message expressed in a non-negotiated language, recognizing to what extent the message is capable of being discerned, and processing the message, to the extent the message can be discerned.

In particular, the sequence of steps 500 begins at step 502. In step 502, receiving device 100 receives an incoming message in a non-negotiated language.

In step 504, receiving device 100 determines whether a message has been received. If no message has been received, processing returns to step 502, to await an incoming message. If a message has been received in step 504, processing proceeds to step 506.

In step 506, the parser 204 parses the received message. The parser 204 identifies a start tag 302, an end tag 304, and any optional data 306 contained in the received message. After parsing the received message in step 506, processing proceeds to step 508.

In step 508, receiving device 100 determines whether it recognizes the start tag. Tag recognizer 202 determines to what extent the message is capable of being discerned. In one aspect of the invention, tag recognizer 202 compares the current start tag to a table of recognized tags to determine the extent to which the message can be discerned. If the current start tag is not recognized in step 508, processing proceeds to step 510. If the current start tag is recognized, processing proceeds to step 512.

In step 510, the message portion containing an unrecognized start tag can be discarded or ignored. Controller 206 does not need to act upon any portion of the incoming message that it is not capable of discerning.

In step 512, controller 206 acts upon the received message to the extent that the message can be discerned. Acting upon the message can include issuing one or more instructions or messages. Controller 206 can execute an instruction associated with the received message. Receiving device 100 can than act upon the message, for instance, by displaying optional data 306 in the message, generate a sound, and so forth.

In step 514, receiving device 100 determines if it has reached the end of the received message. If there is at least one more pair of start tag 302 and end tag 304, processing proceeds to step 506, for parsing of the next message portion. If there is no other pair of start tag 302 and end tag 304, then the receiving device 100 has reached the end of the received message and the sequence of steps 500 executed by receiving device 100 is complete.

FIG. 6 illustrates a wireless environment 600 in accordance with the invention. The wireless environment 600 can include multiple nodes 602, 604, 606, 608, and 610 that can either transmit or receive signals. For example, the node can be located in a device such as a Personal Digital Assistant (hereinafter “PDA”) 612, a fax machine 614, a printer 616, a vending machine 618, or a magazine stand 620. In this embodiment, each node operates in a wireless format, although it can easily be wired.

PDA 612 is a receiving device that receives messages from any number of the sending devices 614, 616, 618, 620. Vending machine 618 may be a soda machine, candy machine or any other type of vending machine.

Sending devices 614, 616, 618, 620, broadcast or send messages to any or all receivers 612 in wireless environment 600.

PDA 612 receives messages from any or all-sending devices 614, 616, 618, 620, in the environment. PDA 612 can act upon any or all messages that are received and understood.

Based on the forgoing, it should be appreciated by those skilled in the art, that the present invention permits quick exchange of highly useful computing or human information between two connected devices or services to facilitate management of single or multiple connections with varied services. For example, telephones with graphical user interfaces are able to display connection states including hold, busy or dropped as well as images of the caller for quick reference. A receptionist is able to determine how to route calls based on advanced information.

Additionally, the present invention allows devices to be added to networks that contain their own image identity and configuration in human readable format without having to individually send that configuration to the existing devices. For example, a multiparty conference call may be setup for specific users within a wireless network by selecting their icons, then a phone icon (not shown). When a new user arrives into an area, the user can be added by selecting them as well.

Further, the present invention allows network servers or wireless basestations to deploy a flexible link setup and maintenance protocol that can add information at any time to add new services without disrupting services to previously deployed clients or mobiles. Also, new clients or mobiles can be deployed that communicate with new or even old servers or basestations. Thus, backward and forward link setup and maintenance compatibility is enabled.

Although the present invention has been described in detail, those skilled in the art should understand that they can make various changes, substitutions and alterations herein without departing from the spirit and scope of the invention in its broadest form.

What is claimed is:

1. A method of processing a received message, the method comprising:
receiving a message expressed in a non-negotiated language;
recognizing to what extent the message is capable of being discerned; and
processing the message, to the extent the message can be discerned.

2. The method of claim 1, further comprising the step of: disregarding the message to the extent the message is not capable of being discerned.

3. The method of claim 1, wherein the message comprises: a start tag and an end tag.

4. The method of claim 3, wherein the message further comprises data encapsulated between said start and end tag.

5. The method of claim 1, wherein said step of processing the message, comprises executing an instruction associated with the message.

6. A method of processing received messages, the method comprising:
receiving messages in a non-negotiated language;
parsing said messages to determine if said messages are decipherable; and
processing those messages determined to be decipherable.

7. The method of claim 6, further comprising the step of: disregarding any messages not decipherable.

8. The method of claim 6, wherein the step of processing comprises executing an instruction associated with at least one of said comprehended messages.

9. The method of claim 6, wherein the step of processing comprises storing data associated with at least one of said comprehended messages.

10. The method of claim 6, wherein said comprehended messages are written in a human readable text language.

11. The method of claim 8, wherein said executing an instruction comprises displaying information associated with at least one of said deciphered messages.

12. The method of claim 6, wherein at least one of the messages comprises a start tag, an end tag and data encapsulated between said tags.

13. The method of claim 6, wherein at least one of the messages is written in an Extensible Markup Language.

14. A system for receiving at least one message expressed in a non-negotiated language, comprising:
a tag recognizer configured to determine to what extent the message can be processed by analyzing tags in the message; and
a controller configured to process the message based on the determination of the tag recognizer and to disregard an unrecognized message.

15. The system of claim 14, wherein the message is a readable text language.

16. The system of claim 14, wherein at least one message includes a start tag and an end tag.

17. The system of claim 14, wherein said system is a personal digital assistant (PDA) for receiving the message in a wireless environment whereby no fixed handshaking protocol is used to receive the message.

18. The system of claim 17, wherein said PDA displays information to a user to the extent the message is discerned by said parser.

19. The system of claim 14, wherein the message is written in an Extensible Text Markup Language.
